(19) United States
(12) Patent Application Publication
(10) Pub. No.: US 2015/0271583 A1
(43) Pub. Date: Sep. 24, 2015

(54) SHOWERHEAD AUDIO SPEAKER SYSTEM

(71) Applicant: AS IP Holdco, LLC, Piscataway, NJ (US)

(72) Inventor: Lee Chung Wan, Kaiping (CN)

(21) Appl. No.: 14/656,973

(22) Filed: Mar. 13, 2015

Related U.S. Application Data
(60) Provisional application No. 61/954,797, filed on Mar. 18, 2014.

(51) Int. Cl. H04R 1/02; B05B 1/18

(52) U.S. Cl. CPC H04R 1/028; B05B 1/185

(57) ABSTRACT

A shower audio system includes a speaker unit having a housing configured to removably mount about an outer periphery of a showerhead. The housing is a waterproof enclosure for speaker unit components, including speakers (which may variously include speaker drivers such as woofers, mid-range speakers, tweeters, and cross-overs), audio source connectors, audio electronics for processing audio input data and outputting audio, and a power source. Control buttons, such as an on/off switch, volume controls, and/or an audio source input selector are mounted on the outer surface of the housing to facilitate user access. The audio system also includes an audio source, which can be an external device such as, for example, a smartphone. The audio system renders audio, which can be wirelessly streamed from the audio source located outside of the shower, via the speaker unit mounted on the showerhead out of the way of the shower stream.

### CROSS-REFERENCE TO RELATED PROVISIONAL APPLICATION

This application claims the benefit of U.S. Provisional Application No. 61/954,797, filed on Mar. 18, 2014, the disclosure of which is hereby incorporated by reference herein in its entirety.

### FIELD OF THE INVENTION

The present invention generally relates to audio systems for use in the shower.

### BACKGROUND OF THE INVENTION

The shower can be a great place to listen to the news, weather, or music while preparing to start a new day—making an otherwise dull routine useful, interesting, and just plain fun. Audio systems developed for use in the shower share many features with non-shower audio systems, with the exception that systems designed for use in the shower must be waterproof. Like typical audio systems, the audio source for shower audio systems can vary. It is well known to use audio sources such as AM/FM radio tuners and/or compact discs (CDs) for shower audio systems.

Conventional shower audio systems include stand-alone units designed to hang from the shower arm or mount to the shower walls or surrounds using suction cups or other fasteners. These systems have the benefit of accepting many different types of audio sources, including large media sources such as CDs, given that system form factor considerations can be made secondary to functionality considerations. However, these stand-alone shower audio systems tend to be quite conspicuous and rarely fit into a coordinated design aesthetic. Showerhead integrated audio systems have also been developed. While such integrated systems solve some of the design drawbacks associated with stand-alone systems, they can require altering the flow pattern of the water ejected from the showerhead, reducing the functionality of the showerhead itself.

### SUMMARY OF THE INVENTION

Generally speaking, it is an object of the present invention to provide a shower audio system that avoids disadvantages of prior art constructions.

According to an embodiment of the present invention, a shower audio speaker system includes a showerhead mountable audio speaker unit configured to removably fit around the periphery of the showerhead, out of the way of the shower stream. A waterproof housing encloses the speaker components, including one or more speakers (which may variously include speaker drivers such as woofers, mid-range speakers, tweeters, and cross-overs), one or more audio source connectors, audio electronics for processing audio data from an audio source and outputting audio, and one or more power sources, such as a battery. One or more control buttons, such as an on/off switch, volume controls, and/or an audio source input selector may be mounted on an outer surface of the housing to facilitate user access.

According to preferred embodiments of the present invention, the inventive speaker unit is configured to receive and render audio content streamed wirelessly from the audio source. The speaker unit can also process audio from a wired audio source.

The speaker unit may be removably mountable on the showerhead using magnets, clips, VELCRO, a friction fit, or any other suitable fastener or combination of fasteners.

In some embodiments, the speaker unit may be configured for use with a particular showerhead. That is, the showerhead may be dimensioned to form a seamless, aesthetically pleasing product when coupled with the speaker unit. Further, one or more attachment mechanisms may be provided on or within the showerhead housing to facilitate coupling to the speaker unit. In some embodiments, for example, the attachment mechanism may include magnets mounted within the showerhead that align with corresponding magnets mounted within the speaker unit housing. The attachment mechanism may also include clips, VELCRO, or fasteners that are complementary to similar mechanisms provided on the speaker unit housing.

In some embodiments, the speaker unit housing may be a universal housing designed to couple to a variety of showerheads. To facilitate such functionality, the housing may be configured to removably couple to adapters designed to fit particular showerheads.

Still other objects and advantages of the present invention will in part be obvious and will in part be apparent from the specification.

The present invention accordingly comprises the features of construction, combination of elements, and arrangement of parts all as exemplified in the constructions herein set forth, and the scope of invention will be indicated in the claims.

### BRIEF DESCRIPTION OF THE DRAWINGS

For a fuller understanding of the inventive embodiments, reference is had to the following description taken in connection with the accompanying drawings in which:

FIG. 1 shows a shower audio system in accordance with an embodiment of the present invention;

FIG. 2 shows the speaker unit of the shower audio system depicted in FIG. 1 disengaged from the showerhead;

FIG. 3 is an exploded view of a showerhead and speaker unit in accordance with an embodiment of the present invention;

FIG. 4 is a front plan view of a speaker unit mounted to a showerhead in accordance with an embodiment of the present invention;

FIG. 5 is a side elevational view of the speaker unit mounted to the showerhead depicted in FIG. 4;

FIG. 6 is a rear plan view of the speaker unit mounted to the showerhead depicted in FIGS. 4 and 5; and

FIGS. 7-10 are various perspective views of the speaker unit mounted to the showerhead depicted in FIGS. 4-6.

### DETAILED DESCRIPTION OF THE PREFERRED EMBODIMENTS

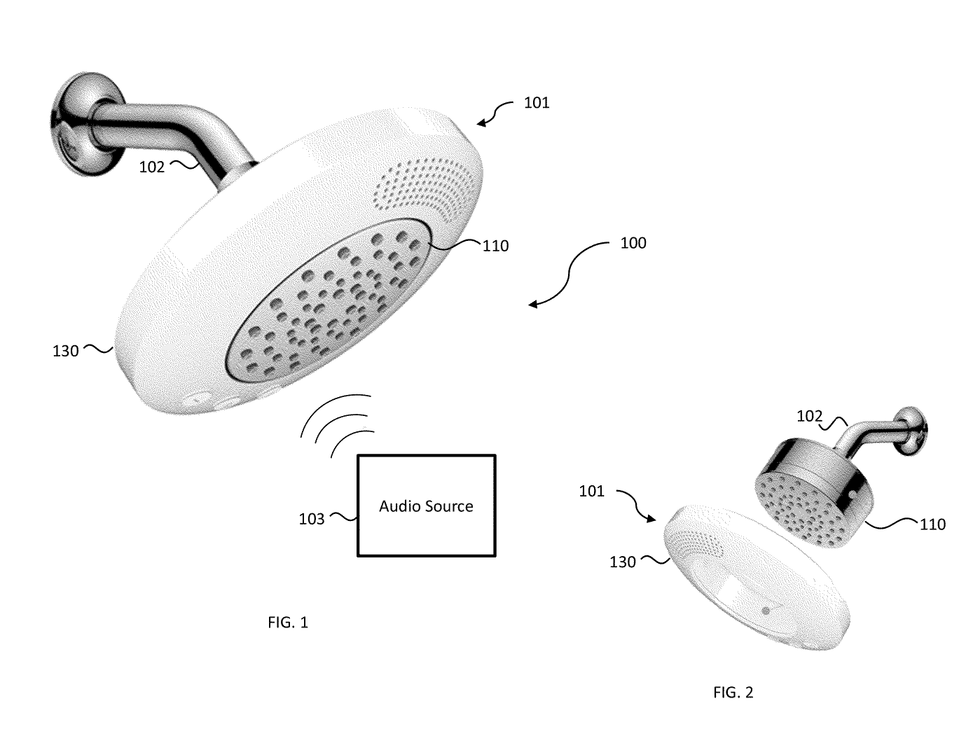

FIG. 1 shows a shower audio system 100 according to an embodiment of the present invention. Shower audio system 100 includes a speaker unit 101 having a speaker-unit housing 130 mountable on a showerhead 110 extending from a shower arm 102. As described in greater detail below, speaker-unit housing 130 provides a waterproof enclosure for the various speaker unit components.

Shower audio system 100 also includes an audio source 103, which can be an external electronic device such as, for example, a smartphone or other digital audio player. Shower audio system 100 can enhance a user's shower experience by rendering audio streamed wirelessly from the audio source 103 located outside of the shower. Audio may be reproduced via speaker unit 101, mountable out of the way of the shower stream at the periphery of showerhead 110.

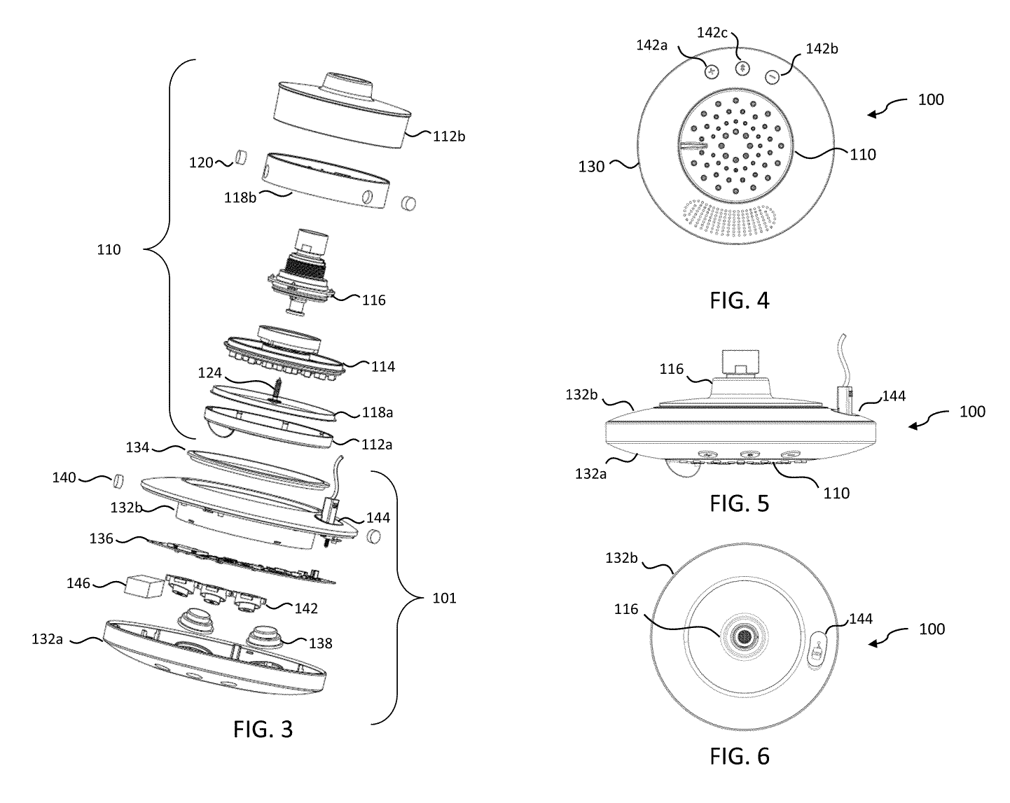

FIG. 3 is an exploded view of showerhead 110 and speaker-unit housing 130 according to an embodiment of the present invention. It should be understood that showerhead 110 represents merely one implementation of a typical showerhead for use in the inventive audio system. Other showerhead implementations may be possible, and speaker unit housings, as disclosed herein, may be adapted to be paired with a variety of showerheads of different shapes and types, such as, for example, square, oval, hexagonal, rectangular, or irregularly shaped showerheads.

As is generally known in the showerhead art, showerhead 110 includes front showerhead body 112a, rear showerhead body 112b, spray face 114, shower arm coupling 116, front gasket 118a, rear gasket 118b, showerhead magnets 120, and fastener 124. Front showerhead body 112a, rear showerhead body 112b, and spray face 114, which includes spray nozzles for ejecting water from showerhead 110, form the outer housing of showerhead 110. Accordingly, these components may be formed from or finished with materials that are aesthetically pleasing as well as resistant to damage or deterioration from prolonged operation in a warm, humid shower environment. Such materials may include stainless steel, chrome, or plastic, for example.

Fastener 124 is insertable into an aperture in spray face 114 and rotatably coupleable to a threaded aperture in shower arm coupling 116 to attach spray face 114 to shower arm coupling 116. Fastener 124 may be any type of suitable fastener, such as, for example, a screw or bolt. Shower arm coupling 124 includes a threaded end designed to threadably engage a threaded aperture of rear showerhead body 112b in a water-tight manner (e.g., using conical threads to form a labyrinth seal). In other embodiments, a washer or other suitable gasket or seal is interposed between a stop of shower arm coupling 124 and a corresponding surface of rear showerhead body 112b to provide a water-tight seal between the two components. Finally, shower arm coupling 124 is coupleable to a shower arm, such as shower arm 102 of FIG. 1 (e.g., by threadably engaging the shower arm). Front showerhead body 112a may threadably engage or be clipped onto spray face 114 and/or rear showerhead body 112b to complete the showerhead enclosure.

Front gasket 118a is interposed between front showerhead body 112a and spray face 114 to protect the components and to ensure that the radial edge of spray face 114 makes a water-tight seal with showerhead body components 112a and 112b. Similarly, rear gasket 118b forms a water-tight seal at and/or around the radial edge of spray face 114 between rear showerhead body 112b and shower arm coupling 124.

According to an embodiment of the present invention, rear gasket 118b includes one or more recesses 118c for accommodating showerhead magnets 120. Any suitable number of recesses 118c and showerhead magnets 120 may be employed to provide removable magnetic coupling between showerhead 110 and speaker-unit housing 130 around the radial circumference of showerhead 110. For example, in some embodiments, nine showerhead magnets 120 may be inserted into nine corresponding recesses 118c, while in other embodiments, three showerhead magnets 120 may be inserted into three corresponding recesses 118c. The number and placement of showerhead magnets 120 provided in showerhead 110 may depend on any of a number of factors, including the shape of showerhead 110, the strength of showerhead magnets 120, the weight of speaker unit 101, and/or the number and placement of magnets provided inside speaker-unit housing 130.

In order to provide a showerhead audio system that does not affect the flow of water through spray face 114, speaker-unit housing 130 is shaped to mount snugly around at least a portion of the radial perimeter of showerhead 110. This is illustrated in FIGS. 1 and 2, which show ring-shaped speaker unit 101 engaged and disengaged, respectively, from cylindrically-shaped showerhead 110.

Referring back to FIG. 3, speaker-unit housing 130 includes front housing body 132a, rear housing body 132b, nonslip component 134, audio electronics 136, speakers 138, housing magnets 140, buttons 142, external input jack 144, and battery 146. Like showerhead 110, speaker-unit housing 130 may be formed from or finished with any suitable material capable of withstanding warm and humid shower environments (e.g., stainless steel, chrome, or plastic). According to various embodiments, speaker-unit housing 130 may be formed from and/or plated with the same material or a different material used for showerhead 110.

Front housing body 132a and rear housing body 132b form a water-tight enclosure for the interior components of speaker-unit housing 130. Preventing water from penetrating speaker-unit housing 130 protects the internal audio components against damage. Accordingly, regardless of how front housing body 132a and rear housing body 132b are joined together (e.g., using a threaded connection, one or more clips, or one or more fasteners), a gasket or like seal is preferably interposed therebetween to provide a water-tight seal.

One or more portions of speaker-unit housing 130 may include recesses for accommodating housing magnets 140. These recesses and magnets can be positioned around the interior radial surface of speaker-unit housing 130 at locations that correspond to the positions of showerhead magnets 120 in showerhead 110. In some embodiments, the number and position of housing magnets 140 may directly correspond to the number and position of showerhead magnets 120 in showerhead 110. In other embodiments, however, more or fewer housing magnets 140 may be provided in order to ease alignment between housing magnets 140 and showerhead magnets 120. Thus, in on particular embodiment, nine showerhead magnets 120 may be provided in showerhead 110 and three housing magnets 140 may be provided in speaker-unit housing 130. When speaker-unit housing 130 is placed around showerhead 110, showerhead magnets 120 and housing magnets 140 removably couple speaker-unit housing 130 to showerhead 110. In some embodiments, showerhead magnets 120 or housing magnets 140 may be replaced by magnetically attractive elements, such as ferromagnetic materials, for example.

In other embodiments, in lieu of or in addition to the magnets, clips, a hook and loop fastener (e.g., VELCRO®), a friction fit, or any suitable fastener or combination of fasteners may be employed to couple speaker-unit housing 130 to showerhead 110.

Tongue-and-groove elements may additionally be employed to provide proper alignment between showerhead 110 and speaker-unit housing 130. For example, showerhead 110 may include one or more longitudinal tongue elements (not shown) configured to mate with corresponding longitudinal grooves formed on the surface of speaker-unit housing 130. One skilled in the art would appreciate, however, that the grooves may be formed on showerhead 110 and tongues may be formed on speaker-unit housing 130.

Nonslip component 134 can be affixed to the inner radial edge of speaker-unit housing 130 to act as a nonslip layer between speaker-unit housing 130 and showerhead 110 to prevent movement of speaker-unit housing 130 relative to showerhead 110 when the two components are coupled together. Nonslip component 134 may be formed from any suitable friction-enhancing material, such as rubber or silicone, for example. Nonslip component 134 can be affixed to speaker-unit housing 130 in any suitable manner, such as using an adhesive or a friction fit, for example.

In some embodiments, nonslip component 134 is an adapter that permits speaker-unit housing 130 to be mounted on a particular showerhead. Accordingly, using different nonslip components, speaker-unit housing 130 can be adapted for use with a variety of showerheads. In general, the outer dimensions of the nonslip component may be designed to fit speaker-unit housing 130, while the inner dimensions of the nonslip component may be designed to fit the particular showerhead. Nonslip component may also be configured to provide an additional water penetration barrier.

Speaker-unit housing 130, which can be water-tight, encloses the speaker components. These speaker components include one or more speakers 138, which may variously include speaker drivers such as woofers, mid-range speakers, tweeters, and cross-overs.

Audio electronics 136 are also enclosed in speaker-unit housing 130 to receive audio signals from the audio input source and output audio through speakers 138. For embodiments in which audio electronics 136 are configured to receive digital audio signals, a digital-analog-convertor (DAC) can be used to convert the digital audio signals into audio suitable for output via speakers 138. Audio electronics 136 may be fixedly mounted within speaker-unit housing 130 using any suitable combination of fasteners and adhesives. In some embodiments, audio electronics 136 may be encased in a water-tight housing within speaker-unit housing 130.

Battery 146, which may provide electric power to audio electronics 136 and speakers 138 via one or more power supply lines, may also be enclosed within an additional water-tight housing in speaker-unit housing 130. It should be appreciated that an alternative power source to battery 146, such as electricity generated by the flow of water through the showerhead may be used to provide power to audio electronics 136.

The audio input source may be any suitable input source capable of supplying an analog or digital audio signal to audio electronics 136. Such audio input sources may include, for example, an AM/FM radio tuner, a satellite radio tuner, a CD player, and/or a digital audio player. Audio electronics 136 may be configured to handle any or all of the foregoing audio sources and/or similar audio sources yet to be developed. According to various embodiments, speaker-unit housing 130 may include one or more wireless data interfaces, such as a BLUETOOTH® transceiver, a WiFi® transceiver, and/or an AIRPLAY® transceiver available by Apple Inc. of Cupertino, Calif. Speaker unit housing may also include one or more external input jacks 144 to accept an audio signal from a wired source (e.g., a digital media player). Examples of external input jacks 144 can include headphone jacks, HDMI jacks, optical digital jacks, stereo RCA jacks, phono jacks, and/or USB jacks, for example.

A variety of buttons 142 may be mounted in speaker unit housing for controlling various aspects of the audio system. In the embodiments depicted in FIG. 1, button 142a and 142b provide volume down/up controls, respectively. Button 142c may facilitate pairing speaker-unit housing 130 with a BLUETOOTH® enabled audio input source. Other buttons and/or switches may also be provided on speaker-unit housing 130 to control other audio system functions, such as an on/off function, an audio input source select function, and/or audio source specific functions (e.g., FWD, RWD, Play/Pause, channel select, and/or tuning functions), for example.

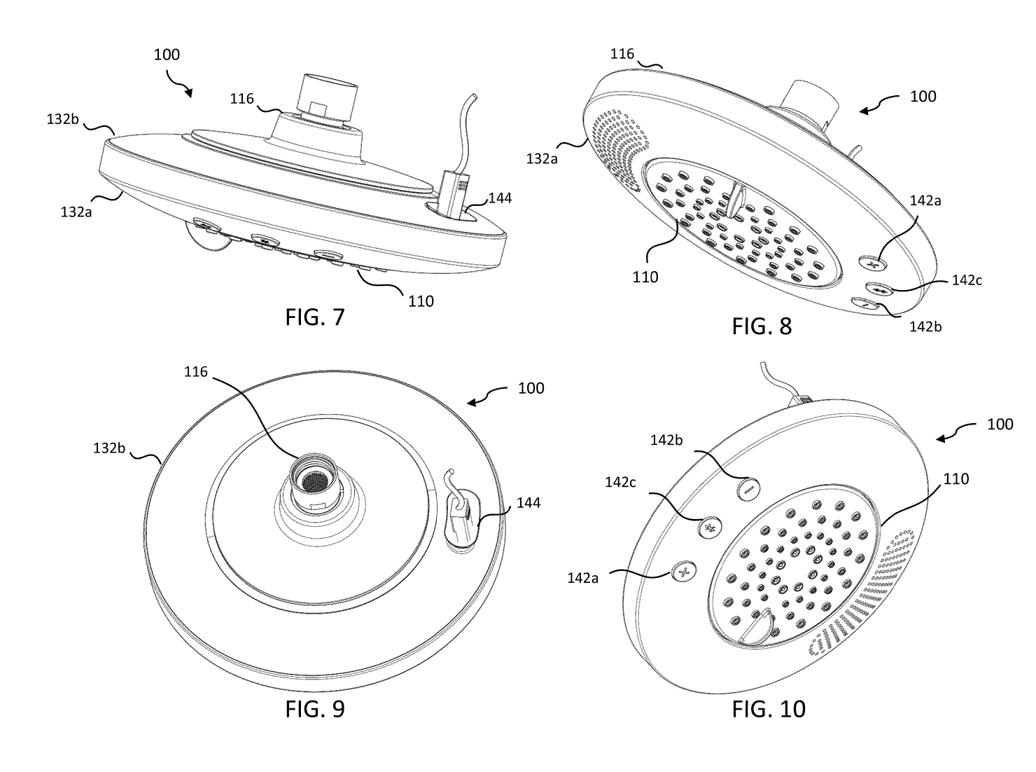

FIGS. 4-10 show further views of shower audio system 100, in accordance with some embodiments.

Accordingly, the present invention provides a showerhead audio system that eliminates the need for a stand-alone shower audio system and enhances a user's shower experience by rendering audio, which can be wirelessly streamed from an audio source located outside of the shower, via a speaker unit removably mountable on the showerhead out of the way of the shower stream.

Embodiments of the present invention can be implemented in the form of control logic in software or hardware or a combination of both. For example, particular embodiments can be implemented by using application specific integrated circuits or programmed logic circuits. In general, the functions of particular embodiments can be achieved by any suitable means as is known in the art. Communication or transfer of data or instructions may be wired, wireless, or by any other suitable means. Also, elements of the inventive embodiments can be enabled or disabled as is useful in accordance with a particular application.

Furthermore, it should be understood that the aspects, features and advantages made apparent from the foregoing are efficiently attained and, since certain changes may be made in the disclosed inventive embodiments without departing from the spirit and scope of the invention, it is intended that all matter contained herein shall be interpreted as illustrative and not in a limiting sense.

It is also to be understood that the following claims are intended to cover all of the generic and specific features of the invention herein described, and all statements of the scope of the invention that, as a matter of language, might be said to fall there between.

What is claimed is:

1. A showerhead audio speaker system, comprising:
a speaker unit housing comprising a bore configured to receive a showerhead;
a first coupling mechanism provided one of on and in the speaker unit housing, the first coupling mechanism configured to removably attach the speaker unit housing to the showerhead; and
audio electronics mounted within and enclosed by the speaker unit housing.

2. The showerhead audio speaker system of claim 1, further comprising:
the showerhead fluidly coupled to a water source.

3. The showerhead audio speaker system of claim 2, further comprising:
a second coupling mechanism provided one of on and in the showerhead, the second coupling configured to cooperate with the first coupling mechanism to removably attach the speaker unit housing to an outer periphery of the showerhead.

4. The showerhead audio speaker system of claim 3, wherein the first coupling mechanism is a magnetic coupling.

5. The showerhead audio speaker system of claim 4, wherein the magnetic coupling comprises a first plurality of magnets mounted in and enclosed by the speaker housing unit.

6. The showerhead audio speaker system of claim 5, wherein the second coupling mechanism comprises a second plurality of magnets mounted in and enclosed by the showerhead.

7. The showerhead audio speaker system of claim 6, wherein a number of magnets of the first plurality of magnets is one of more than, equal to, or fewer than a number of magnets of the second plurality of magnets.

8. The showerhead audio speaker system of claim 3, further comprising:
a plurality of magnets; and
a plurality of magnetically attractive elements, wherein the first coupling mechanism comprises one of the plurality of magnets and the plurality of magnetically attractive elements, and wherein the second coupling mechanism comprises the other of the plurality of magnets and the plurality of magnetically attractive elements.

9. The showerhead audio speaker system of claim 3, wherein the first and second coupling mechanisms comprise at least one of:
complementary hook and loop fastners;
complementary clips; and
friction fit engagement members.

10. The showerhead audio speaker system of claim 3, further comprising complementary alignment members provided on an external surface of the bore and on the outer periphery of the showerhead, the complementary alignment members aligning the first coupling mechanism with the second coupling mechanism to facilitate coupling between the speaker unit housing and the showerhead.

11. The showerhead audio speaker system of claim 1, further comprising:
a nonslip component comprising a friction enhancing material affixed to the speaker unit housing at least partially within the bore.

12. The showerhead audio speaker system of claim 11, wherein the nonslip component has outer dimensions corresponding to the speaker unit housing and inner dimensions corresponding to an outer periphery of the showerhead, the nonslip component being interchangeable with other nonslip components to adapt the speaker unit housing to different corresponding showerheads.

13. The showerhead audio speaker system of claim 1, further comprising:
speakers and a power source communicatively coupled to the audio electronics.

14. The showerhead audio speaker system of claim 13, the power source comprising at least one of
a battery; and
an electric generator powered by flow of water through the showerhead.

15. The showerhead audio speaker system of claim 1, the audio electronics comprising at least one audio input source.

16. The showerhead audio speaker system of claim 15, the audio electronics comprising a transceiver providing wireless interface to the at least one audio input source.

17. The showerhead audio speaker system of claim 15, the audio electronics comprising a wired interface to the at least one audio input via one or more external jacks.

18. The showerhead audio speaker system of claim 15, the audio electronics comprising at least one input mechanism accessible one of on and outside the speaker housing unit for controlling the at least one audio input source.

19. The showerhead audio speaker system of claim 1, wherein the speaker housing unit is water-tight.

20. A showerhead audio speaker system, comprising:
a showerhead comprising:
a spray face having a plurality of fluid-ejecting nozzles formed thereon; and
an outer peripheral surface extending substantially perpendicularly away from the spray face;
a water-tight ring-shaped speaker unit comprising:
a bore configured to engage the outer peripheral surface; and
speaker unit components enclosed by the water-tight ring-shaped speaker unit; and
a coupling mechanism removably coupling the water-tight ring-shaped speaker unit to the showerhead.

21. The showerhead audio speaker system of claim 20, further comprising:
a water-tight housing mounted in the water-tight ring-shaped speaker unit, wherein the speaker components are mounted in and enclosed within the water-tight housing.

22. The showerhead audio speaker system of claim 20, the audio electronics comprising at least one of a wired and a wireless data interface for receiving an audio signal from an external device, the audio signal being audibly reproducible by the speaker unit components.
